(19) United States
(12) Patent Application Publication
(10) Pub. No.: US 2024/0099177 A1
(43) Pub. Date: Mar. 28, 2024

(54) METHODS AND SYSTEMS FOR DETERMINING OPERATIONAL RANGES OF A TRACTOR AND ITS IMPLEMENTS

(71) Applicant: MAHINDRA & MAHINDRA LIMITED, Chengalpattu (IN)

(72) Inventors: N Saravanan, Chengalpattu (IN); PARTHA SARATHI SINGHA, Chengalpattu (IN); PAVITHRA SUNDARAM, Chengalpattu (IN); RISHABH SONI, Chengalpattu (IN); A SIVAKUMAR, Chengalpattu (IN); SABARINATH N, Chengalpattu (IN); ARJUN P, Chengalpattu (IN)

(73) Assignee: MAHINDRA & MAHINDRA LIMITED, Chengalpattu (IN)

(21) Appl. No.: 18/247,537

(22) PCT Filed: Mar. 3, 2022
(86) PCT No.: PCT/IN2022/050190

§ 371 Date: Mar. 31, 2023

(30) Foreign Application Priority Data
Jun. 22, 2021 (IN) 202141028053

(51) Int. Cl. A01B 79/00; A01B 59/06; A01B 67/00

(52) U.S. Cl. CPC A01B 79/005; A01B 59/06; A01B 67/00; A01B 33/021

(57) ABSTRACT

Embodiments determine a draft force based on forces at hitch points of the tractor, to determine type of soil, on which the tractor is plying. Embodiments determine rotational peripheral velocity of the implement and forward velocity of the tractor. Embodiments provide recommendations for adjusting the rotational peripheral velocity of the implement and the forward velocity of the tractor based on the soil type, the rotational peripheral velocity of the implement, and the forward velocity of the tractor. The recommendation is provided, if the ratio of the rotational peripheral velocity of the implement and the forward velocity of the tractor falls outside an optimal range.

### CROSS REFERENCE TO RELATED APPLICATION

This application is based on and derives the benefit of Indian Application 202141028053 filed on 22 Jun., 2021, the contents of which are incorporated herein by reference.

### TECHNICAL FIELD

Embodiments herein relate to managing operation of tractors and/or implements of tractors, and more particularly to methods and systems for determining an optimal operational range of forward velocity of a tractor and an optimal operational range of peripheral velocity of an of the tractor.

### BACKGROUND

The quality of operation of a tractor and/or pulverization of soil (of an area/or a field), on which the tractor is operated, can be affected by a forward velocity of the tractor and a peripheral velocity of an implement (such as rotavator) connected to the tractor. Currently, tractor users may not be able to determine the optimal value at which the forward velocity of a tractor needs to be operated. The tractor users may not be able to set the peripheral velocity of the rotavator to an appropriate value. The effect of the combination of the forward velocity of the tractor and the peripheral velocity of the rotavator on the pulverization of the soil can be significant, which in turn can affect the quality of operation of the tractor.

It is generally observed that the values of parameters, viz., the forward velocity of operation and the peripheral velocity of the rotavator, undergo changes based on the condition of the soil. The condition of the soil can refer to the type of the soil, i.e., hard soil, medium soil or soft soil. As the values of the forward velocity of operation and the peripheral velocity of the rotavator are sensitive to the type of the soil, it may be necessary to regulate the values of these parameters based on the type of the soil. Currently, the tractor users may not be able to follow the variations in the values of these parameters based on the type of the soil. Therefore, the tractor users may not be able to control the effects on the pulverization of the soil and the quality of operation of the tractor.

### OBJECTS OF THE DISCLOSED EMBODIMENTS

The principal object of the embodiments herein is to classify/categorize soil, on which a tractor is operating, into types or conditions; and determine an optimal operational range for forward velocity of operation of the tractor and an optimal operational range for peripheral velocity of an implement of the tractor, based on the type or condition of the soil.

Another object of the embodiments herein is to classify the soil type or condition based on a draft force, wherein the soil type or condition can be classified as hard soil, medium soil, or soft soil wherein the draft force is an accumulation of horizontal axial forces sensed by the load cells in two lower links and a top link attached to at least one hitch point of the tractor.

Another object of the embodiments herein is to recommend a user of the tractor to set/control the forward velocity of the tractor within the determined optimal operational range of the forward velocity of operation of the tractor, and set/control the peripheral velocity of the implement within the determined optimal operational range of the peripheral velocity of the implement.

Another object of the embodiments herein is to display the optimal operational range for forward velocity of operation of the tractor and the optimal operational range for peripheral velocity of the implement corresponding to the type or condition of the soil, on which the tractor is operating.

### BRIEF DESCRIPTION OF FIGURES

Embodiments herein are illustrated in the accompanying drawings, through out which like reference letters indicate corresponding parts in the various figures. The embodiments herein will be better understood from the following description with reference to the drawings, in which:

FIG. 1 is a flowchart depicting a method for providing recommendations to set an optimal forward operating velocity of a tractor and an optimal peripheral operating velocity of a rotavator connected to the tractor, according to embodiments as disclosed herein;

FIG. 2 depicts an example arrangement for measuring a draft force experienced at links of hitch points of the tractor and for sending the recommendations for setting the peripheral velocity of the rotavator and the forward velocity of the tractor, according to embodiments as disclosed herein;

FIG. 3 depicts various units of an example system configured to measure draft force experienced at links of hitch points of a tractor and determining an optimal operating range of forward velocity of the tractor and an optimal operating range of rotational peripheral velocity of a rotavator connected to the tractor, according to embodiments as disclosed herein;

FIG. 4 depicts an arrangement for measuring the rotational peripheral velocity of a blade of the rotavator, according to embodiments as disclosed herein;

FIG. 5 depicts an arrangement for measuring the forward velocity of the tractor, according to embodiments as disclosed herein; and

FIGS. 6a-6c depict example User Interfaces (UIs) displayed on an electronic device/IoT device to view type/conditions of soil, and receive recommendations to control the rotational peripheral velocity of the blade of the rotavator and the forward velocity of the tractor, according to embodiments as disclosed herein.

### DETAILED DESCRIPTION

The embodiments herein and the various features and advantageous details thereof are explained more fully with reference to the non-limiting embodiments that are illustrated in the accompanying drawings and detailed in the following description. Descriptions of well-known components and processing techniques are omitted so as to not unnecessarily obscure the embodiments herein. The examples used herein are intended merely to facilitate an understanding of ways in which the embodiments herein may be practiced and to further enable those of skill in the art to practice the embodiments herein. Accordingly, the examples should not be construed as limiting the scope of the embodiments herein.

Embodiments herein disclose methods and systems for determining type/condition of soil, on which a tractor is operating, and determining an optimal ratio of peripheral velocity of an implement of the tractor and forward velocity of the tractor based on determined type/condition of the soil. In an example, the implement can be a power harrow, rotavator, rotary tiller, vibratory tiller and so on. Hereinafter, the rotavator has been considered as an example implement. The embodiments include providing a recommendation to adjust the peripheral velocity of the rotavator and the forward velocity of the tractor based on optimal operational values of each of the peripheral velocity of the rotavator and the forward velocity of the tractor. It should be obvious to a person skilled in the art that likewise recommendations can be provided for adjusting the peripheral velocities of all types of tractor implements, along with the forward velocity of the tractor, based on the optimal operational values of the peripheral velocities of the tractor implements, and the optimal operational values of the forward velocity of the tractor.

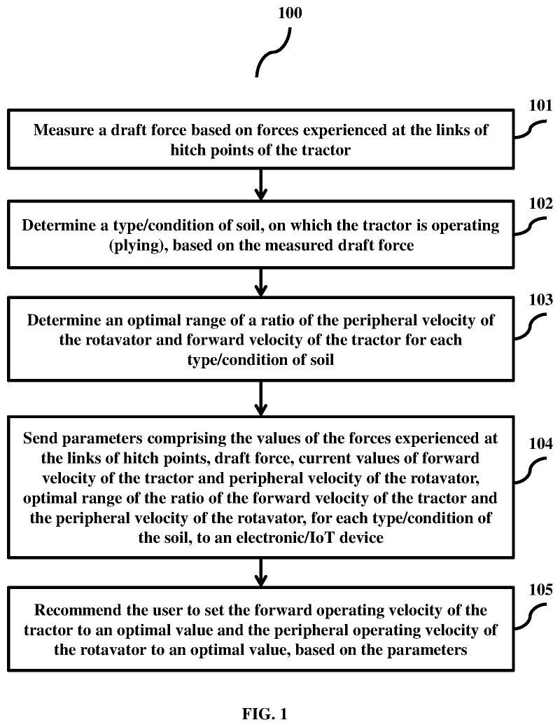

Referring now to the drawings and more particularly to methods and systems for FIGS. 1 through 6c, where similar reference characters denote corresponding features consistently throughout the figures, there are shown preferred embodiments.

Embodiments herein provide methods and systems for determining type/condition of soil, on which a tractor is operating, and determining an optimal ratio of peripheral velocity of a rotavator connected to the tractor and forward velocity of the tractor corresponding to the type/condition of the soil. The tractor can have hitch points, wherein load cells are present in the links of the hitch points. The links are right lower link, left lower link, and top link. The load cells can sense forces experienced at the right lower link, left lower link, and top link, of the hitch points of the tractor. The embodiments include determining values of the forces experienced at each of the three links based on the sensing by the load cells. The embodiments include computing a draft force based on the force experienced at the left lower link, the left lower link, and the top link.

Embodiments herein include determining the type or the condition of the soil based on the draft force. If the draft force is less than a first predefined threshold force, the soil can be classified or categorized as soft soil. If it is determined the draft force is greater than the first predefined threshold force, but less than a second predefined threshold force, the soil can be classified as medium-hard soil. If the draft force is less than a first predefined threshold force, the soil can be classified or categorized as hard soil. The embodiments include determining, for each of the soft soil, medium-hard soil, and hard soil, an optimal operating range of the peripheral velocity of the rotavator and an optimal operating range of the forward velocity of the tractor. The embodiments include determining an optimal range of ratio of the peripheral velocity of the rotavator and the forward velocity of the tractor, for each of the soft soil, medium-hard soil, and hard soil, based on the corresponding optimal operating range of the peripheral velocity of the rotavator and the optimal operating range of the forward velocity of the tractor.

Embodiments herein include determining the current value of the forward velocity of the tractor and the peripheral velocity of the rotavator using sensors. If the ratio of the peripheral velocity of the rotavator and the forward velocity of the tractor (for soft soil, medium-hard soil, or hard soil) does not lie in the (corresponding) optimal range of ratio of the peripheral velocity of the rotavator and the forward velocity of the tractor, the embodiments include sending recommendations, to an electronic device/Internet of Things (IoT) device. The recommendation can be either of: increase the optimal range of ratio of the peripheral velocity of the rotavator and decrease the forward velocity of the tractor or decrease the optimal range of ratio of the peripheral velocity of the rotavator and increase the forward velocity of the tractor.

FIG. 1 is a flowchart 100 depicting a method for recommending an optimal forward operating velocity of a tractor and an optimal peripheral operating velocity of a rotavator connected to the tractor, according to embodiments as disclosed herein. At step 101, the method includes measuring a draft force, based on forces experienced at the links of hitch points of the tractor. In an example, consider that the tractor comprises of three hitch points. There are three links on the hitch points, viz., a right lower link, a left lower link, and a top link. The embodiments include determining forces experienced at the left lower link, right lower link, and the top link. The forces experienced at the lower link, the right lower link, and the top link can be sensed by load cells, The load cells present in the right lower link, the left lower link, and the top link can sense the forces experienced at the right lower link, the left lower link, and the top link. In an embodiment, the load cells in the three links (of the three hitch points) can be configured to sense horizontal axial force being experienced at the three links.

In an embodiment, the draft force can be computed based on at least one of the force experienced at the left lower link, the experienced at the right lower link, and the force experienced at the top link. In an embodiment, the draft force can be obtained by accumulating the force experienced at the left lower link, the force experienced at the right lower link, and the force experienced at the top link. If the accumulation of the three forces on the hitch point links results in a positive value, the embodiments determine that compression force is being experienced. If the accumulation of the three forces on the hitch point links results in a negative value, the embodiments determine that tension force is being experienced.

Further, the embodiments include determining the forward velocity of the tractor and the peripheral rotational velocity of the blade of the rotavator connected to the rear of the tractor.

At step 102, the method includes determining the type/condition of the soil, on which the tractor is operating, based on the determined draft force. In an embodiment, the type/condition of the soil can be determined either as soft soil, medium-hard soil, or hard soil. In an embodiment, if the value of the draft force falls in the range 0-1000 N (Newton), the type/condition of the soil can be considered as soft soil. If the value of the draft force falls in the range 1000-2000 N, the type/condition of the soil can be considered as medium-hard soil. If the value of the draft force is greater than 2000 N, the type/condition of the soil can be considered as hard soil. It is to be noted that the draft force is a tension force.

At step 103, the method includes determining an optimal range of a ratio of the peripheral velocity of the rotavator and forward velocity of the tractor for each type/condition of soil. The embodiments include determining an optimal operating range of the forward velocity of the tractor and an optimal operating range of the peripheral velocity of the rotavator for each type/condition of soil. The embodiments include determining the optimal range of ratio of the forward velocity of the tractor and the peripheral velocity of the rotavator, based on the optimal operating range of the forward velocity of the tractor and the optimal operating range of the peripheral velocity of the rotavator.

In an embodiment, the optimal operating range of the forward velocity of the tractor is specifying the maximum and minimum values of the forward velocity of the tractor. Similarly, the optimal operating range of peripheral velocity of the rotavator is specifying the maximum and minimum values of the peripheral velocity of the rotavator. Therefore, the ratio of the maximum value of the ratio of the peripheral velocity of the rotavator and the maximum value of the forward velocity of the tractor specifies the maximum value of the optimal range of the ratio of the peripheral velocity of the rotavator and the forward velocity of the tractor. Similarly, the ratio of the minimum value of the ratio of the peripheral velocity of the rotavator and the minimum value of the forward velocity of the tractor specifies the minimum value of the optimal range of the ratio of the peripheral velocity of the rotavator and the forward velocity of the tractor.

At step 104, the method includes sending parameters comprising the values of the forces experienced at the links of hitch points of the tractor, the draft force, current values of the forward velocity of the tractor and the peripheral velocity of the rotavator, the optimal range of the ratio of the forward velocity of the tractor and the peripheral velocity of the rotavator, for each type/condition of the soil, to an electronic device or an Internet of Things (IoT) device. In an embodiment, the tractor can send the values of the forces experienced at the right lower link, left lower link, and the top link.

The electronic device/IoT device can be connected to the tractor by a wired or wireless means. In an embodiment, the electronic device/IoT device can display the forces experienced at the links of hitch points of the tractor, the draft force, current values of the forward velocity of the tractor and the peripheral velocity of the rotavator, the optimal range of ratio of the forward velocity of the tractor and the peripheral velocity of the rotavator, for each type/condition of the soil. The electronic device/IoT device can display the optimal operating range of the forward velocity of the tractor and the optimal operating range of the peripheral velocity of the rotavator, for each type/condition of the soil.

At step 105, the method includes recommending the user to set the forward operating velocity of the tractor to an optimal value and the peripheral operating velocity of the rotavator to an optimal value, based on the parameters. In an embodiment, if it is determined that the ratio of the peripheral velocity of the rotavator and the forward velocity of the tractor does lie within the optimal range of the ratio of the peripheral velocity of the rotavator and the forward velocity of the tractor, for a particular type or condition of the soil, the embodiments includes recommending the user of the electronic device/IoT device to control the peripheral velocity of the rotavator and/or the forward velocity of the tractor. If the ratio of the peripheral velocity of the rotavator and the forward velocity of the tractor does is less than the minimum value in the optimal range of the ratio of the peripheral velocity of the rotavator and the forward velocity of the tractor, the embodiments include recommending the user to increase the peripheral velocity of the rotavator and decrease the forward velocity of the tractor.

Similarly, if the ratio of the peripheral velocity of the rotavator and the forward velocity of the tractor does is greater than the maximum value in the optimal range of the ratio of the peripheral velocity of the rotavator and the forward velocity of the tractor, the embodiments include recommending the user to decrease the peripheral velocity of the rotavator and increase the forward velocity of the tractor.

The various actions in the flowchart 100 may be performed in the order presented, in a different order, or simultaneously. Further, in some embodiments, some actions listed in FIG. 1 may be omitted.

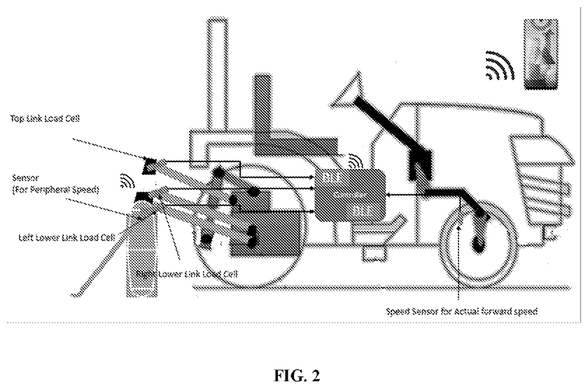

FIG. 2 depicts an example arrangement for measuring the draft force experienced at the links of the hitch points of the tractor and for sending the recommendations for setting the peripheral velocity of the rotavator and the forward velocity of the tractor, according to embodiments as disclosed herein. As depicted in FIG. 2, load cells are present in the right lower link, left lower link, and top link, of the hitch points of the tractor. The load cells have the capability of measuring the forces experienced at the right lower link, left lower link, and top link, of the hitch points of the tractor. The arrangement includes sensors, which are configured for measuring the forward velocity of the tractor and the peripheral velocity of the rotavator.

The arrangement includes a controller, which can receive the measured values of the forces experienced at each of the three links of the hitch points of the tractor. The controller can receive the forward velocity of the tractor measured by the sensor configured to measure the forward velocity of the tractor. The controller can receive the measured value of the peripheral velocity of the rotavator (measured by the sensor configured to measure the peripheral velocity of the rotavator) using a wireless means. In an embodiment, the wireless means can be, but not limited to, Ultrawideband communication, Bluetooth, Near field communication, and so on.

The controller can compute a draft force based on the received values of the forces experienced at each of the three links of the hitch points of the tractor. The controller can determine the type/condition of the soil based on the draft force. The controller can determine the optimal operating range of the forward velocity of the tractor and the optimal operating range of peripheral velocity of the rotavator, which corresponds to a particular type/condition of the soil. In an embodiment, the controller can determine the optimal range of ratio of the peripheral velocity of the rotavator and the forward velocity of the tractor, based on the optimal operating range of the forward velocity of the tractor and the optimal operating range of the peripheral velocity of the rotavator.

The controller can send the optimal range of the ratio of the peripheral velocity of the rotavator and the forward velocity of the tractor to the electronic device, for each type/condition of soil. The controller can send, for each type/condition of soil, the optimal range of the ratio of the peripheral velocity of the rotavator and the forward velocity of the tractor, to the electronic device/IoT device through the wireless means. The controller can send the measured value of the forward velocity of the tractor and the measured value of the peripheral velocity of the rotavator to the electronic device/IoT device. The controller can send the values of the forces experienced at the right lower link, left lower link, and the top link, of the hitch points of the tractor. The controller can send the computed draft force electronic device/IoT device.

If the ratio of the measured values of the peripheral velocity of the rotavator and the forward velocity of the tractor does not lie in the optimal range of the ratio of the peripheral velocity of the rotavator and the forward velocity of the tractor, recommendations are provided to the user to manage the peripheral velocity of the rotavator and the forward velocity of the tractor, such that the ratio of the peripheral velocity of the rotavator and the forward velocity of the tractor falls within the optimal range of the ratio of the peripheral velocity of the rotavator and the forward velocity of the tractor.

In an embodiment, the electronic device or IoT device can display the optimal range of the ratio of the peripheral velocity of the rotavator and the forward velocity of the tractor to the user of the electronic device or IoT device. The electronic device or IoT device can display the (currently measured) value of the forward velocity of the tractor and the (currently measured) value of the peripheral velocity of the rotavator. The electronic device or IoT device can display the values of the forces experienced at the right lower link, left lower link, and the top link, of the hitch points of the tractor. The electronic device or IoT device can display the computed draft force (tension force). The electronic device or IoT device can provide the recommendations, through audio and/or visual indications, if the ratio of the (currently measured) value of the peripheral velocity of the rotavator and the (currently measured) value of the forward velocity of the tractor falls outside the optimal range of the ratio of the peripheral velocity of the rotavator and the forward velocity of the tractor corresponding to a particular type/condition of the soil.

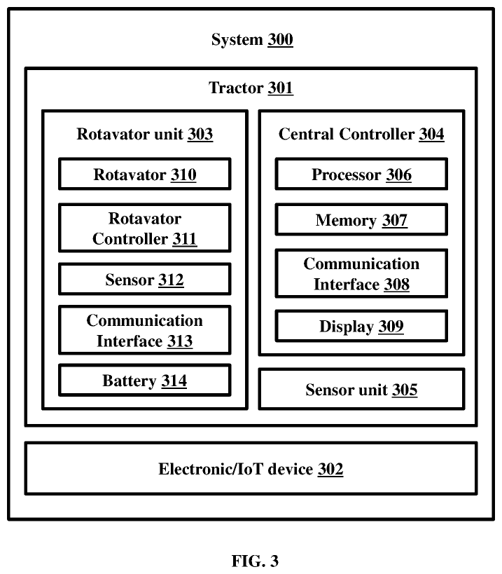

FIG. 3 depicts various units of an example system 300 configured to measure draft force experienced at links of hitch points of a tractor 301 and determining an optimal operating range of forward velocity of the tractor 301 and an optimal rotational operating range of peripheral velocity of a rotavator 310 connected to the tractor 301, according to embodiments as disclosed herein. As depicted in FIG. 3, the example system 300 comprises the tractor 301 and an electronic device or an IoT device 302. The tractor 301 includes a rotavator unit 303, a central controller 304, and a sensor unit 305. The central controller 304 includes a processor 306, a memory 307, a communication interface 308, and a display 309. The rotavator unit 303 comprises the rotavator 310, a rotavator controller 311, a sensor 312, a communication interface 313, and a battery 314.

The tractor 301 can include hitch points (not shown), wherein links (not shown) of the hitch points include load cells (not shown). In an example (depicted in FIG. 2), the tractor 301 is having a three-point linkage with three hitch points. The hitch points can be connected to magneto resistive type load cells, which have the capability of sensing horizontal compression or tension forces experienced at the links of the hitch points. The load cells can measure the forces experienced at the links of the hitch points. In an embodiment, the load cells can measure the forces experienced at left lower link, right lower link, and top link. The sensed forces are fed to the central controller 304 as input signals. The central controller 304 can receive the measured values of the forces experienced at the links (left lower link, right lower link, and top link) of the hitch points.

The central controller 304 can obtain the measured values of the horizontal compression or tension forces experienced at the links of the hitch points. In an embodiment, the central controller 304 (processor 306) can compute a draft force by accumulating the value of the force at the left lower link, the value of the force at the right lower link, and the value of the force at the top link. In an embodiment, the forward velocity of the tractor 301 is sensed by the sensor unit 305. The sensor unit 305 utilizes a sprocket wheel mechanism in the front wheel of the tractor 301 for measuring the forward velocity of the tractor 301. The sensor unit 305 can fed the forward velocity of the tractor 301 to the central controller 304 as an input signal. The central controller 304 can obtain the measured value of the forward velocity of the tractor 301 from the sensor unit 305.

The rotavator unit 303 can measure the value of the rotational peripheral velocity of the blade of the rotavator 310. The rotavator 310 can be attached to the rear of the tractor 301. In an embodiment, the sensor 312 in the rotavator unit 303 can be a hall-effect sensor. The rotational peripheral velocity can be sensed by the hall-effect sensor 312. The hall-effect sensor 312 can provide the measured value of the rotational peripheral velocity of the blade of the rotavator to the rotavator controller 311. The controller 311 of the rotavator unit 303 can send, using the communication interface 313, the value of the rotational peripheral velocity of the blade of the rotavator 310 to the central controller 304.

The central controller 304 can receive the measured value of the rotational peripheral velocity of the blade of the rotavator 310 through the communication interface 308 as an input signal. The battery 313 acts as a power supply of the rotavator unit 303 by providing power to the rotavator controller 311, the sensor 312, and the communication interface 313. The central controller 304 receives the value of the rotational peripheral velocity of the blade of the rotavator 310, from the rotavator controller 311 of the rotavator unit 303, using a wireless means. The wireless means include, but not limited to, Bluetooth, Ultra Wideband Communication, Near Field Communication, and so on. The rotavator controller 311 of the rotavator unit 303 and the central controller 304 can communicate with each other wirelessly through the respective communication interfaces (communication interface 313 and the communication interface 308).

The central controller 304 performs signal conditioning of the input signals, i.e., the values of the forces experienced at the links (left lower link, right lower link, and top link) of the hitch points, the forward velocity of the tractor 301, and the rotational peripheral velocity of the blade of the rotavator 310. The central controller 304 can determine the type/condition of the soil, on which the tractor 301 is plying (operating) based on the draft force (accumulation of the forces experienced at the left lower link, the right lower link, and the top link of the hitch points). The central controller 304 can determine that the type/condition soil is either soft soil, medium soil, or hard soil, based the computed draft force. In an embodiment, if the draft force is less than 1000 N, then the type/condition of the soil is determined as soft soil. If the draft force falls in the range 1000 N-2000 N, then the type/condition of the soil is determined as medium-hard soil. If the draft force is greater than 2000 N, then the type/condition of the soil is determined as hard soil.

The primary function/utility of the rotavator 310 is to pulverize the soil on which the tractor 301 is plying (as the rotavator 310 is a secondary tillage implement). The pulverization of the soil is dependent on two factors, viz., namely the peripheral velocity of the rotavator 310 (U) and the forward velocity of the tractor 301 (V). The pulverization of the soil can be measured in terms of tilling pitch or bite length of the soil. The tilling pitch or the bite length of the soil is dependent on the forward velocity of tractor 301 and the peripheral velocity of the rotavator 310. In an embodiment, a ratio of the peripheral velocity of the rotavator 310 and the forward velocity of the tractor 301 (U/V) needs to lie within an optimal range for ensuring that the quality of pulverization is optimal.

The central controller 304 can determine the range, within which the U/V ratio needs to lie for ensuring that the quality of the pulverization is optimal, based on the optimal operating range of the forward velocity of the tractor 301 and the optimal operating range of peripheral velocity of the rotavator 302. The central controller 304 can determine an optimal operating range of the forward velocity of the tractor 301 and an optimal operating range of the peripheral velocity of the rotavator 310 for each type of soil. The central controller 304 can determine an optimal range of ratio of the forward velocity of the tractor 301 and the peripheral velocity of the rotavator 310, based on the optimal operating range of the forward velocity of the tractor 301 and the optimal operating range of the peripheral velocity of the rotavator 310.

In an embodiment, the values that are covered within the optimal range of ratio of the forward velocity of the tractor 301 and the peripheral velocity of the rotavator 310 can vary on the type/quality of soil on which the tractor is plying. Therefore, the range, within which the U/V ratio needs to lie for ensuring that the quality of the pulverization is optimal, can vary for soft soil, medium-hard soil, and hard soil. The central controller 304 can determine, for each of soft soil, medium-hard soil, and hard soil, the optimal range of the ratio of the peripheral velocity of the rotavator 310 and the forward velocity of the tractor 301.

The central controller 304 can send the optimal range of the ratio of the peripheral velocity of the rotavator 310 and the forward velocity of the tractor 301, to the electronic/IoT device 302, for each type/condition of soil. The central controller 304 can send, for each type/condition of soil, the optimal range of the ratio of the peripheral velocity of the rotavator and the forward velocity of the tractor, to the electronic device/IoT device 302 through the wireless means. The central controller 304 can send the values of the forward velocity of the tractor 301 and the peripheral velocity of the rotavator 310 to the electronic/IoT device 302. The central controller 304 can send the values of the forces experienced at the right lower link, left lower link, and the top link, of the hitch points of the tractor. The central controller 304 can send the value of the draft force electronic/IoT device 302.

The electronic/IoT device 302 can determine whether the U/V ratio is appropriate for ensuring that the quality of the pulverization is optimal based on the measured values of the rotational peripheral velocity of the blade of the rotavator 310 and the forward velocity of the tractor 301. If the U/V ratio is not appropriate (does not fall in the optimal range of the ratio of the peripheral velocity of the rotavator 310 and the forward velocity of the tractor 301), the electronic/IoT device 302 can provide indications to the user. The electronic device/IoT device 302 can display the indications to the user of the tractor 301. The indications can recommend the user to either: increase the rotational peripheral velocity of the blade of the rotavator 310 and decrease the forward velocity of the tractor 301, or decrease the rotational peripheral velocity of the blade of the rotavator 310 and increase the forward velocity of the tractor 301.

FIG. 3 shows exemplary units of the system 300, but it is to be understood that other embodiments are not limited thereon. In other embodiments, the system 300 may include less or more number of units. Further, the labels or names of the units of the system 300 are used only for illustrative purpose and does not limit the scope of the invention. One or more units can be combined together to perform same or substantially similar function in the system 300.

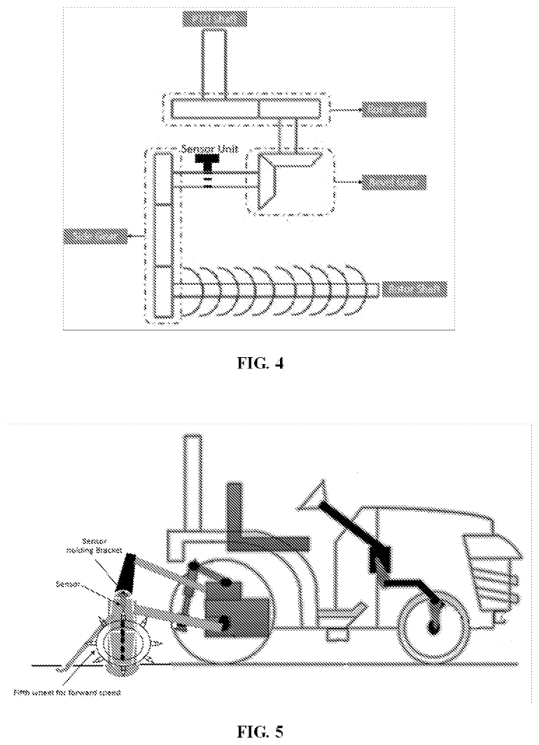

FIG. 4 depicts an arrangement for measuring the rotational peripheral velocity of the blade of the rotavator 310, according to embodiments as disclosed herein. In an embodiment, the rotavator unit 303 can measure the rotational peripheral velocity of the rotavator 301 by measuring number of revolutions undergone by the rotavator blade every minute (Revolutions per Minute (RPM) of the rotavator blade). As depicted in FIG. 4, the sensor 312, configured to measure the RPM of the blade of the rotavator 310, can be placed on a bevel shaft of the rotavator 310. The sensor 312 can sense the RPM of the shaft and an integrated controller (rotavator controller 311) can convert the sensed data into a tangible RPM value signifying the number of revolutions undergone by the blade of the rotavator 310 every minute. The communication interface 313 can send the rotational peripheral velocity of the blade of the rotavator 310 to the central controller 304 wirelessly.

FIG. 5 depicts an arrangement for measuring the forward velocity of the tractor 301, according to embodiments as disclosed herein. The sensor unit 305 can include a wheel velocity sensor for measuring the forward velocity of the tractor 301. The sensor unit 305 can employ a fifth wheel arrangement for measuring the forward velocity of the tractor 301. The fifth wheel arrangement is fitted with the wheel velocity sensor. The value of the forward velocity of the tractor 301 measured using the arrangement is applicable irrespective of the type of tractor drive.

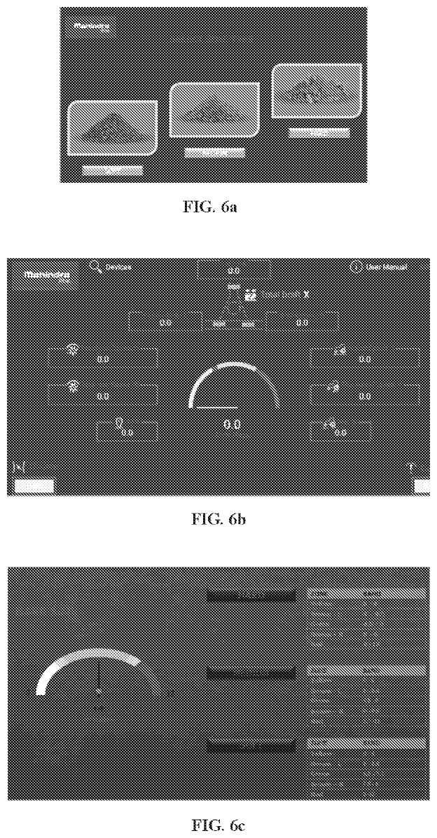

FIGS. 6a-6c depict User Interfaces (UIs) displayed on the electronic device/IoT device to view type/conditions of the soil and receive recommendations to control the rotational peripheral velocity of the blade of the rotavator 310 and the forward velocity of the tractor 301, according to embodiments as disclosed herein. As depicted in FIG. 6a, the user can select a soil type. As depicted in FIG. 6b, the UI can display the values of the forces experienced at the right lower link, left lower link, and the top link, of the hitch points of the tractor 301. The UI can display the measured value of the forward velocity of the tractor 301 and the measured value of the peripheral velocity of the rotavator 310.

The UI can display the range of possible values that the ratio of the peripheral velocity of the rotavator and the forward velocity of the tractor can attain. A portion within the entire range of possible values (green region) represents the optimal range of the ratio of the peripheral velocity of the rotavator and the forward velocity of the tractor. The UI can display the entire range of possible values that the ratio of the peripheral velocity of the rotavator and the forward velocity of the tractor can attain for each type/condition of soil (soft, medium and hard). The values are demonstrated in a tabular form (table-1).

TABLE 1

| S. No | Color | Hard | Medium | Soft |
|---|---|---|---|---|
| 1 | YELLOW | 0-4.5 | 0-4.8 | 0-4.8 |
| 2 | GREEN | 4.5-8 | 4.8-9 | 4.8-7.5 |
| 3 | RED | 8-12 | 9-12 | 7.5-12 |

The UI can display the optimal range of the ratio of the peripheral velocity of the rotavator and the forward velocity of the tractor, for each type or condition of soil (soft, medium and hard). The electronic/IoT device provides recommendations, through audio indications and/or visual indications, if the ratio of the measured value of the peripheral velocity of the rotavator and the measured value of the forward velocity of the tractor falls outside the optimal range of the ratio of the peripheral velocity of the rotavator and the forward velocity of the tractor for a particular type/condition of soil.

If the ratio of the measured value of the peripheral velocity of the rotavator and the measured value of the forward velocity of the tractor falls towards the left of the brown band (left to the green band-towards the yellow band), the embodiments include providing a recommendation to accelerate the peripheral velocity of the rotavator. If the ratio of the measured value of the peripheral velocity of the rotavator and the measured value of the forward velocity of the tractor falls towards the right of the brown band (right to the green band-towards the red band), the embodiments include providing a recommendation to decelerate. If the ratio of the measured value of the peripheral velocity of the rotavator and the measured value of the forward velocity of the tractor falls on the green band, the embodiments include providing a recommendation to hold (do not change gear or throttle settings).

As depicted in FIG. 6c, user manuals can be displayed on the UI. The user manual indicates the entire range of possible values that the ratio of the peripheral velocity of the rotavator and the forward velocity of the tractor can attain for each type/condition of soil (soft, medium and hard). The user manual indicates the optimal range of the ratio of the peripheral velocity of the rotavator and the forward velocity of the tractor, for each type or condition of soil (soft, medium and hard).

The embodiments disclosed herein can be implemented through at least one software program running on at least one hardware device and performing network management functions to control the network elements. The elements shown in FIG. 3 include blocks which can be at least one of a hardware device, or a combination of hardware device and software module.

The embodiments disclosed herein describe methods and systems for determining type/condition of soil, on which a tractor is operating, and determining an optimal ratio of peripheral velocity of an implement of the tractor and forward velocity of the tractor based on determined type/condition of the soil. Therefore, it is understood that the scope of the protection is extended to such a program and in addition to a computer readable means having a message therein, such computer readable storage means contain program code means for implementation of one or more steps of the method, when the program runs on a server or mobile device or any suitable programmable device. The method is implemented in a preferred embodiment through or together with a software program written in example Very high speed integrated circuit Hardware Description Language (VHDL), or any other programming language, or implemented by one or more VHDL or several software modules being executed on at least one hardware device. The hardware device can be any kind of portable device that can be programmed. The device may also include means, which could be, for example, a hardware means, for example, an Application-specific Integrated Circuit (ASIC), or a combination of hardware and software means, for example, an ASIC and a Field Programmable Gate Array (FPGA), or at least one microprocessor and at least one memory with software modules located therein. The method embodiments described herein could be implemented partly in hardware and partly in software. Alternatively, the invention may be implemented on different hardware devices, e.g. using a plurality of Central Processing Units (CPUs).

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the scope of the embodiments as described herein.

1-10. (canceled)

11. A method for determining operational ranges of a tractor and an implement of the tractor, the method comprising:
determining, by the tractor, a type of soil, on which the tractor is plying, based on a draft force, wherein the draft force is based on forces at least one hitch point of the tractor;
determining, by the tractor, a rotational peripheral velocity of the implement, connected to the tractor, and a forward velocity of the tractor;
sending, by the tractor, to an electronic/Internet of Things (IoT) device, the draft force, the rotational peripheral velocity of the implement, and the forward velocity of the tractor; and
providing, by the electronic/Internet of Things (IoT) device, a recommendation to adjust at least one of the rotational peripheral velocity of the implement and the forward velocity of the tractor based on the type of soil, the rotational peripheral velocity of the implement, and the forward velocity of the tractor.

12. The method of claim 11 wherein:
the type of the soil is one of a soft soil, a medium-hard soil, and a hard soil;
the type of soil is soft soil if the draft force is less than a first predefined threshold force;
the type of soil is medium-hard soil if the draft force is greater than the first predefined threshold force and less than a second predefined threshold force; and
the type of soil is hard soil if the draft force is greater than the second predefined threshold force.

13. The method of claim 11 wherein the recommendation is provided if a ratio of the rotational peripheral velocity of the implement and the forward velocity of the tractor falls outside an optimal range associated with a type of soil, and wherein the recommendation is provided through at least one of an audio indication and a visual indication.

14. The method of claim 13 wherein the maximum value of the optimal range for the type of soil is a ratio of maximum value of optimal operational value of the rotational peripheral velocity of the implement for the type of soil and a maximum value of optimal operational value of the forward velocity of the tractor for the type of soil, and wherein the minimum value of the optimal range for the type of soil is the ratio of minimum value of optimal operational value of the rotational peripheral velocity of the implement for the type of soil and a minimum value of optimal operational value of the forward velocity of the tractor for the type of soil.

15. The method of claim 13 wherein the recommendation is to increase the rotational peripheral velocity of the implement and decrease the forward velocity of the tractor, if the ratio of the rotational peripheral velocity of the implement and the forward velocity of the tractor is less than the minimum value of the optimal range for the type of soil, and wherein the recommendation is to decrease the rotational peripheral velocity of the implement and increase the forward velocity of the tractor, if the ratio of the rotational peripheral velocity of the implement and the forward velocity of the tractor is less than the minimum value of the optimal range for the type of soil.

16. A system for determining operational range of a tractor and an implement of the tractor, the system comprising:
the tractor, wherein the tractor is configured to:
determine a type of soil, on which the tractor is plying, based on a draft force, wherein the draft force is based on forces at least one hitch point of the tractor;
determine a rotational peripheral velocity of the implement, connected to the tractor, and a forward velocity of the tractor; and
send the draft force, the rotational peripheral velocity of the implement, and the forward velocity of the tractor, to an electronic/Internet of Things (IoT) device; and
the electronic/IoT device, wherein the electronic/IoT device is configured to provide a recommendation to adjust at least one of the rotational peripheral velocity of the implement and the forward velocity of the tractor based on the type of soil, the rotational peripheral velocity of the implement, and the forward velocity of the tractor.

17. The system of claim 16 wherein:
the type of the soil is one of a soft soil, a medium-hard soil, and a hard soil;
the type of soil is soft soil if the draft force is less than a first predefined threshold force;
the type of soil is medium-hard soil if the draft force is greater than the first predefined threshold force and less than a second predefined threshold force; and
the type of soil is hard soil if the draft force is greater than the second predefined threshold force.

18. The system of claim 16 wherein the recommendation is provided if a ratio of the rotational peripheral velocity of the implement and the forward velocity of the tractor falls outside an optimal range associated with a type of soil, and wherein the recommendation is provided through at least one of an audio indication and a visual indication.

19. The system of claim 18 wherein the maximum value of the optimal range for the type of soil is a ratio of maximum value of optimal operational value of the rotational peripheral velocity of the implement for the type of soil and a maximum value of optimal operational value of the forward velocity of the tractor for the type of soil, and wherein the minimum value of the optimal range for the type of soil is a ratio of minimum value of optimal operational value of the rotational peripheral velocity of the implement for the type of soil and a minimum value of optimal operational value of the forward velocity of the tractor for the type of soil.

20. The system of claim 18 wherein the recommendation is to increase the rotational peripheral velocity of the implement and decrease the forward velocity of the tractor, if the ratio of the rotational peripheral velocity of the implement and the forward velocity of the tractor is less than the minimum value of the optimal range for the type of soil, and wherein the recommendation is to decrease the rotational peripheral velocity of the implement and increase the forward velocity of the tractor, if the ratio of the rotational peripheral velocity of the implement and the forward velocity of the tractor is less than the minimum value of the optimal range for the type of soil.
